(19) United States
(12) Patent Application Publication
(10) Pub. No.: US 2006/0005144 A1
(43) Pub. Date: Jan. 5, 2006

(54) Method for navigating, communicating and working in a network

(76) Inventor: Guy Salomon, Grodinge (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/137,737

(22) Filed: May 25, 2005

Related U.S. Application Data
(63) Continuation-in-part of application No. 10/491,834, filed on Apr. 5, 2004.

(51) Int. Cl. G06F 3/00

(52) U.S. Cl. 715/779

(57) ABSTRACT

The method is for analyzing and searching in a network. A first screen displays a plurality of business segments. Each business segment has sensor points representing subgroups. The conditions of each subgroup are determined by allocating a color to each subgroup. A radar line is swept across the business segments. Each subgroup lights up in the allocated color when the radar line extends across the subgroup. The display may also display a schematic tree structure for the business segments.

### PRIOR APPLICATION

This application is a U.S. national phase application based on International Application No. PCT/US03/05485, filed Feb. 24, 2003, claiming priority from U.S. Provisional Patent Application No. 60/360,163 filed Feb. 25, 2002.

### TECHNICAL FIELD

The present invention relates to a method for navigating, communicating and working in a network, such as an intranet of an organization or the Internet.

### BACKGROUND OF THE INVENTION

It has become quite common for employees and other members of organizations such as companies to work in complicated networks. The networks are often very large and cumbersome to handle. Employees often do not have a good overview of the network and what it can offer. The currently available monitors do not provide a good overview in a clear natural way. There is a need for a more effective method of navigating, communicating and working in a network. The companies of today have become two-dimensional and consist nowadays of both the traditional and the digital dimensions. The digital dimension is out of adequate steering-model for effective understanding, use, collaboration, steering etc. Traditional steering-models take years of implementation before they work, if they ever do, because they are often living a life outside the ordinary operations. The present invention is a new sort of company common steering-model in the shape of a common world of conception or communicative language-structure integrated as a support-model in daily work tools for the new two-dimensional company.

### SUMMARY OF THE INVENTION

The method of the present invention provides a solution to the above-outlined problems. More particularly, the method of the present invention is for a user to navigate in a network. When the system 10 is in a learning mode, a square display system is displayed that has fields that are each associated with separate screens. A screen may be activated by pressing a control key plus a corresponding numerical key such as the digit 1 for the first field. The user may switch from one screen to another by pressing the control command plus the numerical key. The first row of fields are focused on providing tools for the user including tools for a) navigating and search, b) for adjustment of inflow and addition of information, news, reports etc. c) for communication and collaboration. The second row of fields are focused on providing company context such as motivators and steering (plans and results), individualized and role-based information and the third row of fields are focused on providing company content such as product, knowledge and client information. The invention may be reversed and could be provided with standard mode and standard sorting method e.g. role-mode and latest used method.

### BRIEF DESCRIPTION OF THE DRAWINGS

FIG. 1 is a schematic view of a 9-dimensional screen system;

FIG. 2 shows a schematic detailed view of a navigation screen associated with a first field of the system shown in FIG. 1;

FIG. 3 shows a schematic detailed view of a news screen associated with a second field of the system shown in FIG. 1;

FIG. 4 shows a schematic detailed view of a communicator screen associated with a third field of the system shown in FIG. 1;

FIG. 5 shows a schematic detailed view of a motivator and steering screen associated with a fourth field of the system shown in FIG. 1;

FIG. 6 shows a schematic detailed view of an individualized screen associated with the fifth field of the system shown in FIG. 1;

FIG. 7 shows a schematic detailed view of a role-based screen associated with a sixth field of the system shown in FIG. 1;

FIG. 8 shows a schematic detailed view of products/service associated with a seventh field of the system shown in FIG. 1;

FIG. 9 shows a schematic detailed view of a competence screen associated with an eighth field of the system shown in FIG. 1; and

FIG. 10 shows a schematic detailed view of client information associated with a ninth field of the system shown in FIG. 1.

### DETAILED DESCRIPTION

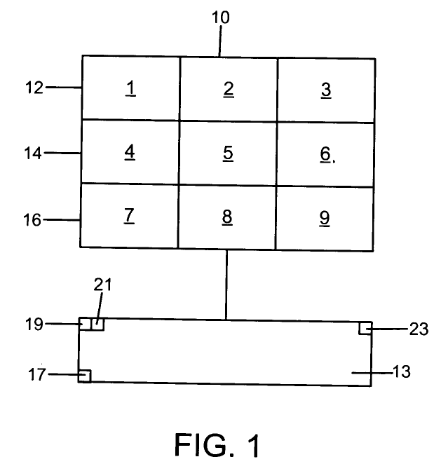

With reference to FIGS. 1-10, the method of the present invention has a nine-dimensional screen system 10 with a top row 12, a middle row 14 and a bottom row 16. The row 12 includes a set of tools for individual navigation and for obtaining news and for all kinds of communication. The row 14 is generally related to the work place of the user such as every day business and working tasks. The row 16 is generally related to company content information such as product, knowledge and client information.

The innovation may be built on the following facts:

1. That information, knowledge and tools has its natural places, relations, demarcation and teamwork with each other and that the box with three rows and columns is probably the most outstanding and most complete structure to use for this purpose.
2. That the human being only can remember about seven things at the same time. The field for the individual in the middle with 8 surrounding fields will be the closest you could come to this fact without sacrificing other critical requirements of the invention.
3. That there is a built-in natural intuitive concept in the triad.
4. That the user can create an intuitive picture of the connection between the three rows and the three columns.
   In this way, the invention makes it easy to handle large network and makes it easier for all participants to co-operate, collaborate and communicate with each other in and around the digital room and it will increase the precision of aim in the decision-process.

It should be noted that the system 10 is not shown to the user unless the user is using an education module of the present invention. The system 10 may be used to navigate, communicate and work within a digital workplace or network such as an intranet system of an organization or the Internet. Each sub-screen of the screen system 10 may be reached from anywhere and enlarged by pressing, for example, the control key 17 on a conventional keyboard 13 and then a numeral key 19 such as the digit 1 to display a navigation screen 18. Of course, any other suitable command may be used to activate the screen 18, as desired. Similarly, by activating the control key 17 and the numeral key 21, that represents the digit 2, the news screen 20 is displayed. In this way, all sub-screens can be reached by using the control key 17 and then different numeral keys so that the last screen 34 may be reached by the activating the control key 17 and the numeral key 23 for the digit 9. It is also possible to click on one of the fields 1-9 with a cursor to activate the corresponding screens 18-34. The user may activate the system of the present invention by, for example, pressing the control key on the keyboard and the desired page number. The system may be deactivated by pressing, for example, the escape key to go back to the original page or just deactivate the frames of system 10.

An important advantage of the present invention is that it provides a good overview of the available functions for navigation, communication and work on an intranet or the Internet without being unduly limited by the screen size of just one screen. The screen system 10 gives the feel of having nine screens that may be numbered from 1-9 like a telephone or a remote control. An important feature of the present invention is that the system is always available to the user and that it is easy to get into and out of the systems as desired.

A majority of Internet users have problems with navigating and communicating on the Internet and other networks because conventional screens are functionally very limited. For example, it is sometimes complicated to reduce and enlarge screen views to obtain an overall view of the functional features that are available on a network. The screen system 10 of the present invention provides a metaphor of standardized tools and work place displays that make it easier for employees to navigate on the network and communicate with others while having access to motivating information such as employee contribution data, sales results etc.

The digital components of the company may be displayed in the screens of the present invention to give the employees a very good standardized overall view while providing access to detailed information, as required. The specific display of the screens may be customized to the position and roles of the different groups of employees. This means that the different groups see certain standardized screen displays, customized for their working-role i.e. role-menus. In this way, a new employee such as a private financial advisor can take advantage of the work done by other private financial advisors so as to get up to speed quickly since the best and most useful tools are immediately available. It should be understood that the private financial advisor may customize some of the screen displays as required. Some of the screens may be common for all employees/positions within a company. One important feature of the present invention is the associative learning process. The employees learn how to use the features by using the invention and may discover more features and knowledge as the invention is being used.

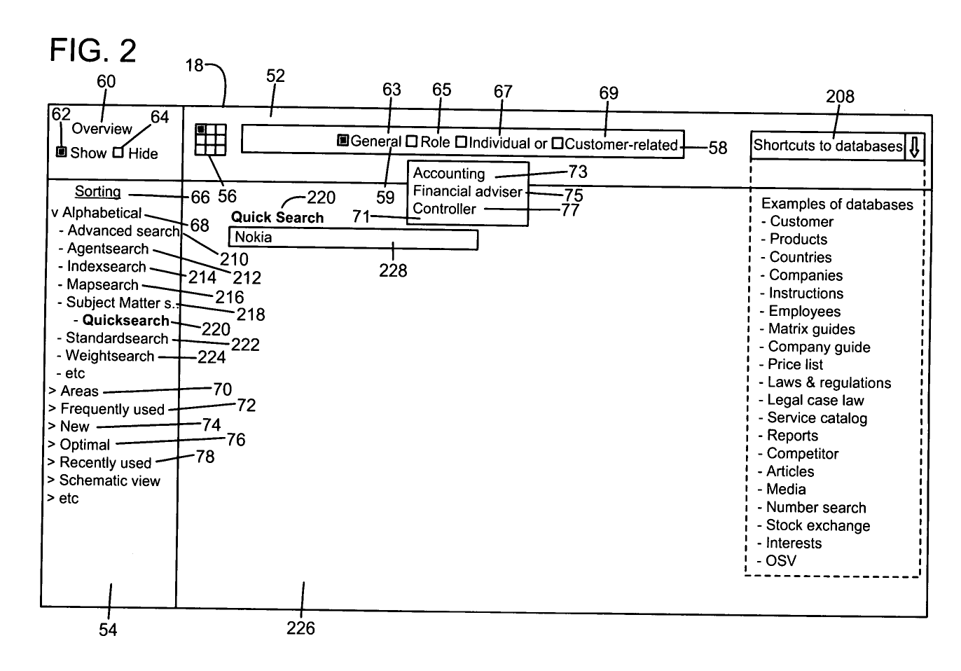

As best shown in FIG. 2, the screen 18 includes tools related to searching and navigation according to the principle of the invention that frequently used information should be easy to access. It is also important that all searching and navigation tools are easy to learn and presented to give the user a good overview. The screen 18 may be displayed from any other screen view by activating the control key 17 and then the desired numeral key that is associated with the desired screen. The screen 18 may have conventional search engines or quick search engines that have been customized to the specific needs of a company or profession. It may also be possible to weigh each search word in view of the importance of the search words. It is advantageous if the navigation/search tools are somewhat standardized so that the tools are easy to use and uniformly used by most employees of a company.

More particularly, the screen 18 is a schematic detailed view that has a quick search function 220 and tool bars 52, 54. The tool bar 52 has an indicator 56 that indicates which screen is being enlarged and a heading 58 so that the user can see which mode version 59, such a navigator screen 18, are being displayed. The mode version 59 may include general 63, role 65, individual 67 and customer related 69 menus. On the left of the screen 18 is an overview function 60 with a display option 62 and a hide option 64 to hide the toolbar 54 and its content. The screen 18 has a sorting function 66 that could be in an alphabetical order 68 or according to subject matter areas 70, the most frequently used search and navigation function 72, the new search and navigation functions 74, the optimal search function 76, the most recently used search and navigation function 78 or a schematic view etc.

An added feature is that the menus in the sorting function may change depending upon whether the screen is in general mode 63, role mode 65, individual mode 67 and customer related mode 69. The general mode 63 may be a general or standard mode that could be used by all the employees. The role mode 65 is a mode that is focused on a certain role in the company, so the menus for that specific role also are focused for that specific role task. By activating the role mode 65, the user may select from a list of pre-defined roles in a menu 71 such as accounting 73, financial advisor 75, controller 77 etc. The individual mode 67 is a customized screen so that the sorting function shown in the bar 54 have been customized to the individual needs of the employee. The customer mode 69 shows menus that have been customized when the employee does work that relate to a particular customer of the company.

The alphabetical function 68 may, for example, include the categories advanced search 210, agent search 212, index search 214, map search 216, subject matter search 218, quick search 220, standard search 222 and weighted search 224. The search, such as the quick search 220, when highlighted by the user may appear in a main screen 226, so that searches may be displayed in a search display 228. The quick search 220 may be used to take the user directly to the desired information page without going through traditional search engines and hit lists. In other words, the user first selects the type of search from the tool bar 54 and then the selected search appears in the screen 226. More particularly, the selected search appears in the quick search 220 and the user types in the search words and then presses enter to activate the search.

Finally, the screen 18 may have a short-cut activator 208 with content related to this particular screen. It may provide access to all kinds of databases sorted from different point of views depending on the mode of the screen including general, role, individual or customer related mode. When the user returns to a screen it may show the latest mode and alternative as the user left it

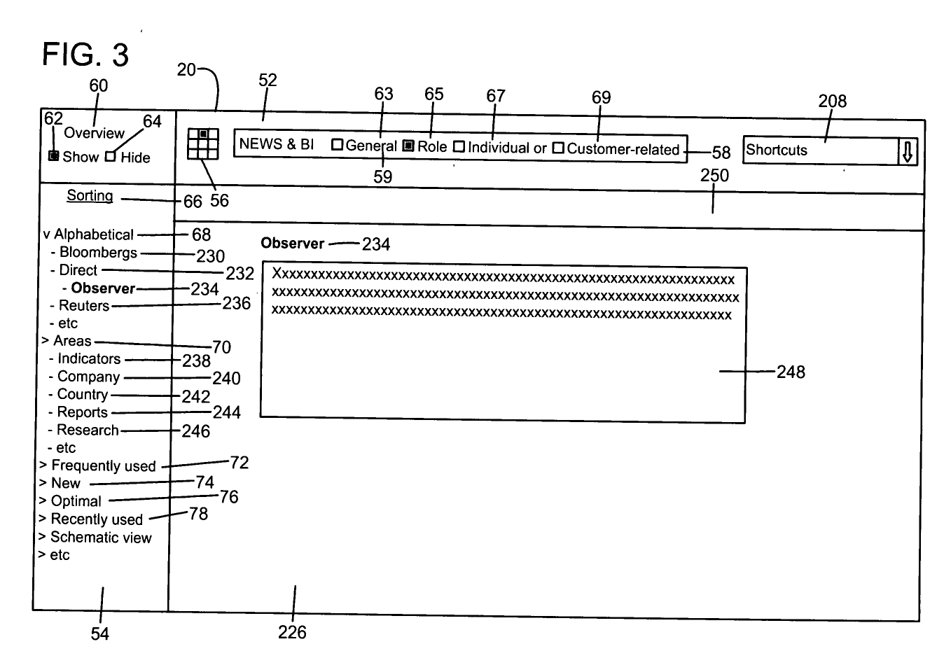

With reference to FIG. 3, the screen 20 may be related to news, business intelligence information and other information obtained from outside worldwide information sources as well as sources specific to the company. The user may use the screen 20 for adjustment or setting of the inflow and additional of information, news and reports etc. One function of the screen 20 is to be the recipient of news and other information that are important for the employee when the screen 20 is in the role mode 65 or individual mode 67. When the screen 20 is in the general mode 63, news that is important to all employees is displayed. The business intelligence may be related to the monitoring of competitors, reports and news within a certain business field. The screen may also include information related to research information in addition to traditional news from newspapers, magazines and database updates.

The screen 20 is very similar to the basic layout of the screen 18. The functions of the screen 20 may be customized to the specific needs of the profession or categories of the employees. The indicator 56 may be set to mark the screen 20 so the user know which screen is being used and the news and business intelligence may be shown in the bar 58. The screen 20 may have a short-cut activator 208 with content related to this particular screen.

The screen 20 has the tool bars 52 and 54 including the sorting function 66. The sorting function 66 may have the sub-categories alphabetical 68, subject matter areas 70, frequently used 72, new 74, optimal 76 and recently used 78. The alphabetical sorting 68 may include categories such as Bloomberg's news source 230, direct news source 232, Observer news source 234, Reuters news source 236 and other suitable news sources. The subject matter 70 may include the sub-categories indicators 238, company 240, country 242, reports 244 and research 246. The highlighted news source, such as the Observer 234, may appear in the screen 226 with news texts appearing in a display 248. The text that is displayed may be focused on news about competitors and the employee's company. The screen may also have an on-line updated barometer 250 that has the latest financial information such as the interest rates, stock prices and stock market indexes.

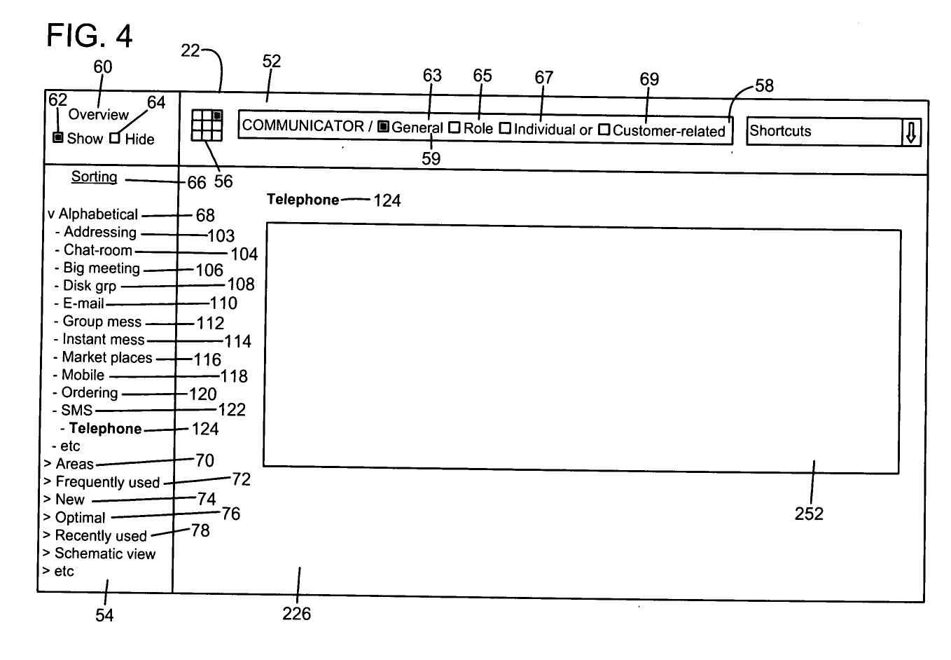

With reference to FIG. 4, the communicator screen 22 may be related to standardized communication tools such as e-mail, chat rooms, group messaging, instant messaging and other communication tools for direct and indirect communication. The user selects the required sorting by activating one of the sorting modes 68-78. More particularly, the screen 22 has the alphabetical sorter 68 that may include the address register 103, chat-room 104, digital meeting 106, discussion group 108, e-mail 110, fax 111, group messaging 112, instant messaging 114, market places 116, mobile phone 118, ordering 120, short message services (SMS) 122 and telephone 124. By highlighting one of the communication tools, the selected method, such as telephone 124, may be displayed in the screen 226. When the telephone 124 is selected, the screen 226 may display a telephone register in a display 252 that may be connected to a database of all the employees of the company or any other suitable telephone database. The database may enable the user to send email and SMS messages directly from the register displayed in the display 252. By selecting the desired role menu version 65, the communication tools provided may be customized so that, for example, sales letters, invoices and tools for administration, are customized according to the role version 65 selected.

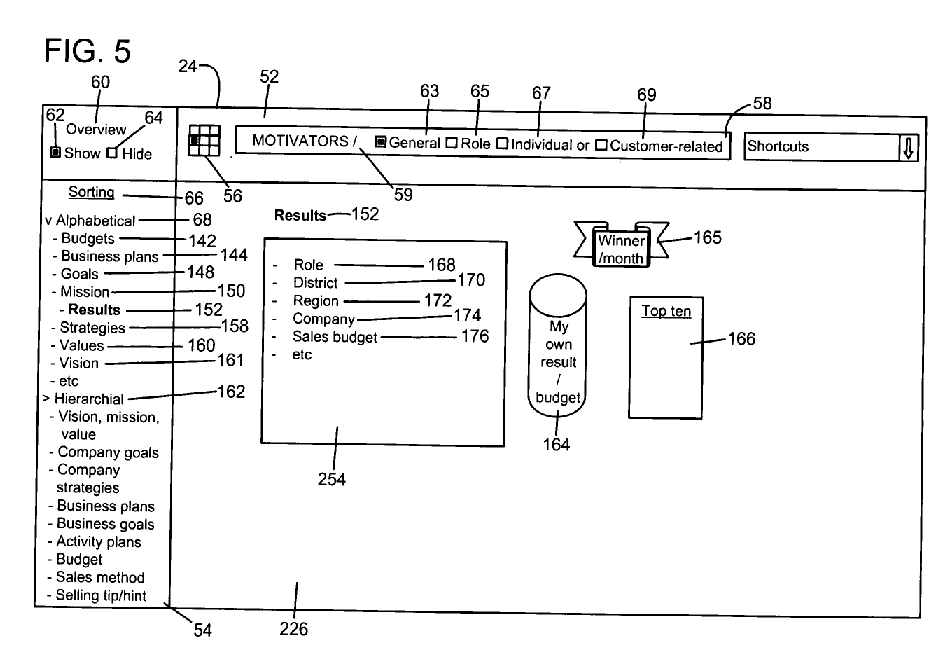

With reference to FIG. 5, the screen 24 may be related to steering-instrument, plans, results, motivators etc. More particularly, the alphabetical sorter 68 may include the sub-categories budgets 142, business plans 144, business goals 148, mission 150, results 152, strategies 158, values 160 ,and vision 161. The alphabetical sorter 68 may include any other suitable segments, as required. If, for example, the result segment 152 is high lighted, a more detailed view of this segment is displayed in the main display 226 including a display 254 with information related to the role 168, the district 170, the region 172, the country 174, sales budget 176 and other suitable items.

An important function of the screen 24 is to include motivating tools to encourage the user/employee to perform better. The screen 24 may also display the total contribution/profit by the employee to the company. Preferably, the screen 24 shows key indicators for the company at different organizational levels.

The screen 24 may include an individual result module 164 that shows the result of the employees' sales performance and a top-ten module 166 that shows the results of the top ten employees' sales performance of the company. The screen 24 may also have a winner of the month display 165 that shows the name of the best performance during a certain time period e.g. the last month.

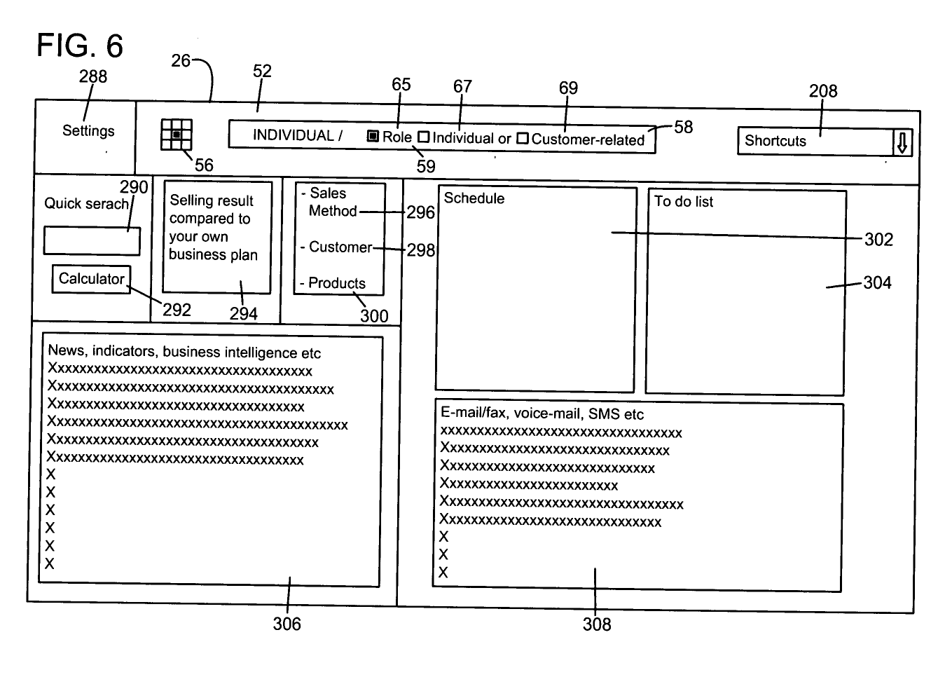

With reference to FIG. 6, the screen 26 may be considered the main screen and could be customized to the specific needs of the company and its employees. It should be noted that the screen 26 does not have a general mode because this screen is customized to the individual user. For example, the screen 26 may include components as aggregated information from screens surrounding the screen 26 and shown in the indicator 56. The screen 26 may, for example, include a list of the latest emails sent or received by the employee, company news and other worthwhile information. More particularly, the screen 26 may have a setting segment 288 that may be used to set the size and content of each and every display area of the screen 26. The screen 26 has a quick search display 290 that is identical to the quick search 220 of the screen 18 and a calculator 292. The screen also has a sales result 294 that is the same as the result display 152 of the screen 24, and. The screen 26 has customer information 298 that corresponds to the customer segment 146 of screen 34. The screen 26 also has a products segment 300 that lists the products available of the company. A schedule 302 may be used to plan meetings etc. and a to-do list 304 to list upcoming commitments and tasks that may have deadlines. The screen 26 further has a chronological news list 306 that lists all incoming news in a chronological order. A filter may be applied to the list 306 so that only relevant news, indicators and business intelligence are shown. The list 306 receives the same information as the screen 20 but all information, regardless of the available sources listed in the screen 20, is shown chronologically. The content of the list 306 is affected by the individual selection 67. The screen 26 also has an effective communicator box 308 that lists all communications received by the employee from others. All correspondence tools, such as email, fax,. voice-mail, SMS etc. are together listed chronologically on the list 308. Preferably, communication tools listed in the screen 22 may be included in the list 308. Finally, the screen 26 may have a short-cut activator 208 that may provide access to relevant individual tools such as templates etc.

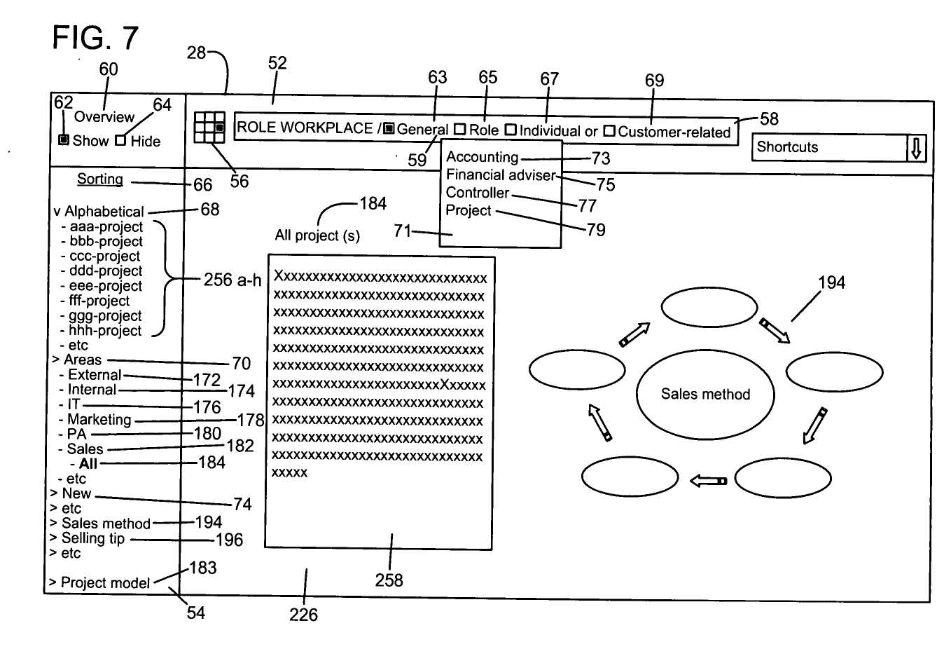

With reference to FIG. 7, the role-based screen 28 may be related to the specific roles and role tools for the specific employee as well as an overall view of all existing roles in the company including the project-role 79. The screen 28 shows the most important information in aggregated form for the specific working role e.g. a sales method 194. A working role can be either horizontal or vertical. For example, if the role of the employee is a financial advisor, the role menu may include information such as stock exchange information, business news, stock and company information and other information specified to the work of a private financial advisor. The role menu may be customized to the specific needs of the user within certain predetermined parameters. The role menu for a corporate financial advisor is to be different from the menu displayed for the private financial advisor.

The bar 54 may have the alphabetical sorter 68, sales methods 194, selling tip 196, a list of projects 256a-h. The subject matter category 70 may include external projects 172, internal projects 174, information technology projects 176, marketing projects 178, PA-projects 180, sales projects 182 and all projects 184. The bar 54 may also include a project model 183. When an item in the bar 54, such as all projects 184, has been activated, text related to all project may appear in a text box 258 on the screen 226. The screen 28 may be designed so that different project lists are displayed depending upon which role menu 65 is activated.

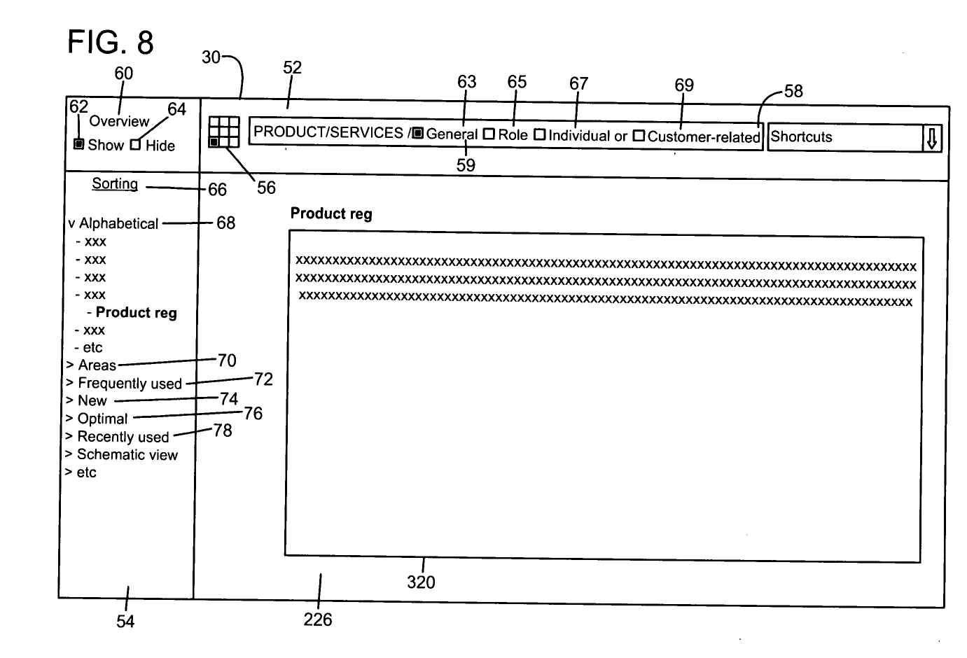

With reference to FIG. 8, the screen 30 may be related to company products and services. It may describe the product process used for each product and the best method for each product.

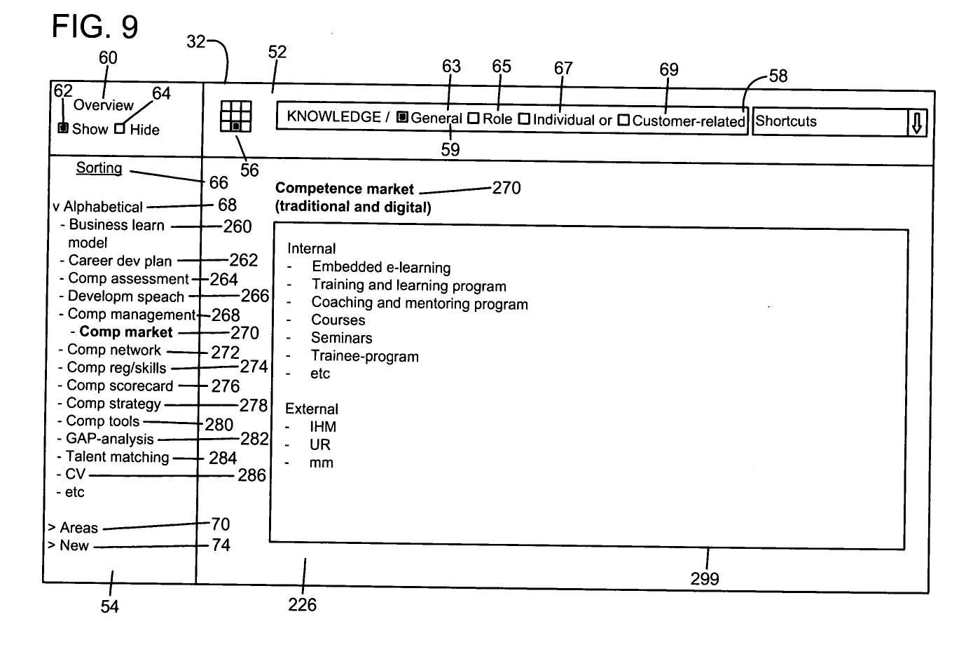

With reference to FIG. 9, the screen 32 may be related to company knowledge and competence and include information and tools related to individual competence development (my personal development). More particularly, the alphabetical sorter 68 may include the sub-categories business learning model 260, career development plan 262, competence assessment 264, development speech 266, competence management 268, competence market 270, competence network 272, competence register (skills database) 274, competence scorecard 276, competence strategy 278, competence tools 280, GAP-analysis 282, talent matching 284 and CV 286. The sorter 68 may include any other suitable segments, as required. If for example, the competence market 270 is highlighted, a more detailed view of this segment is displayed in the main display 226 including a sub-screen 299 with information related to internal competence alternatives 288 such as embedded e-learning 289, training and learning program 290, coaching and mentoring program 291, courses 292, seminars 293, trainee-program 294 and external alternatives 295 such as IHM 296 and IIR 297.

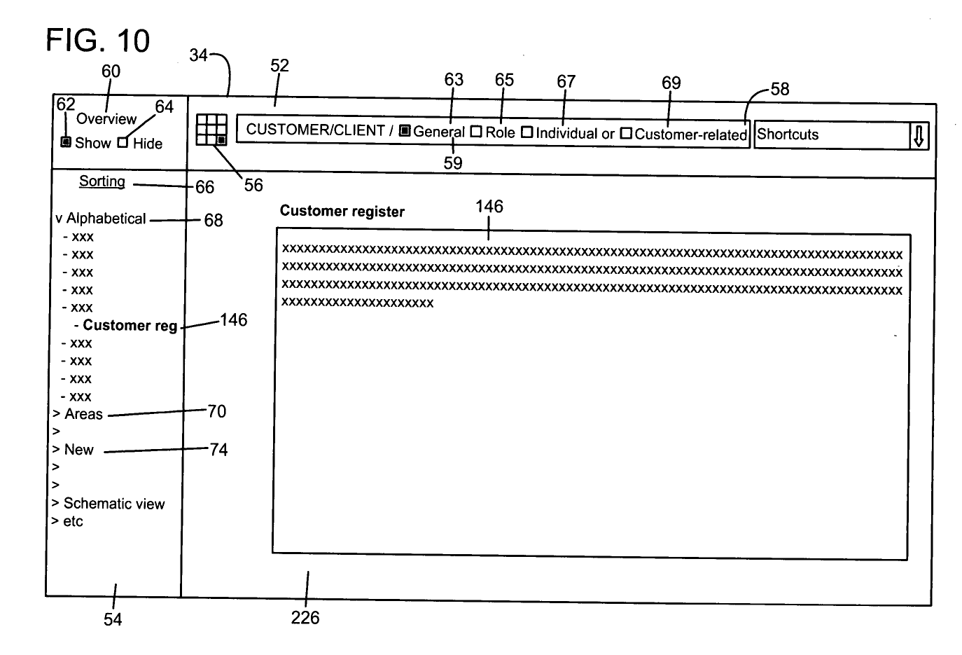

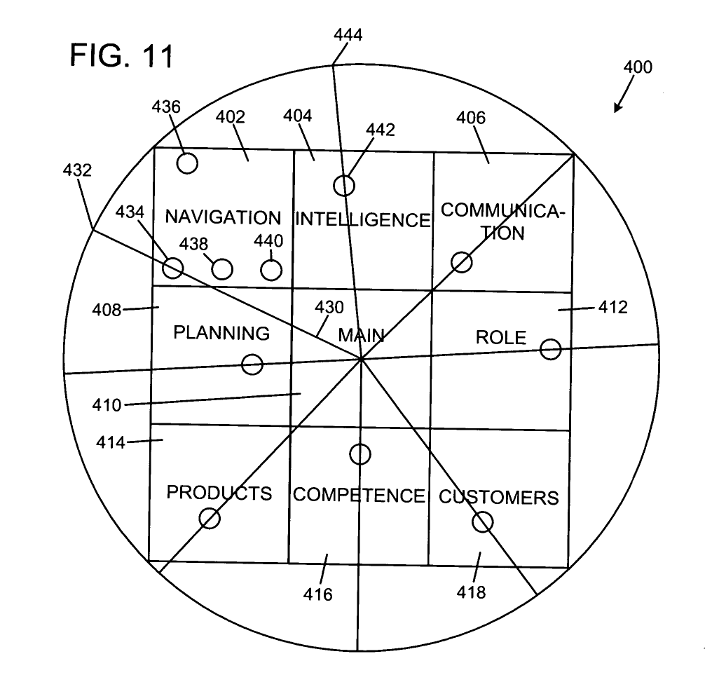

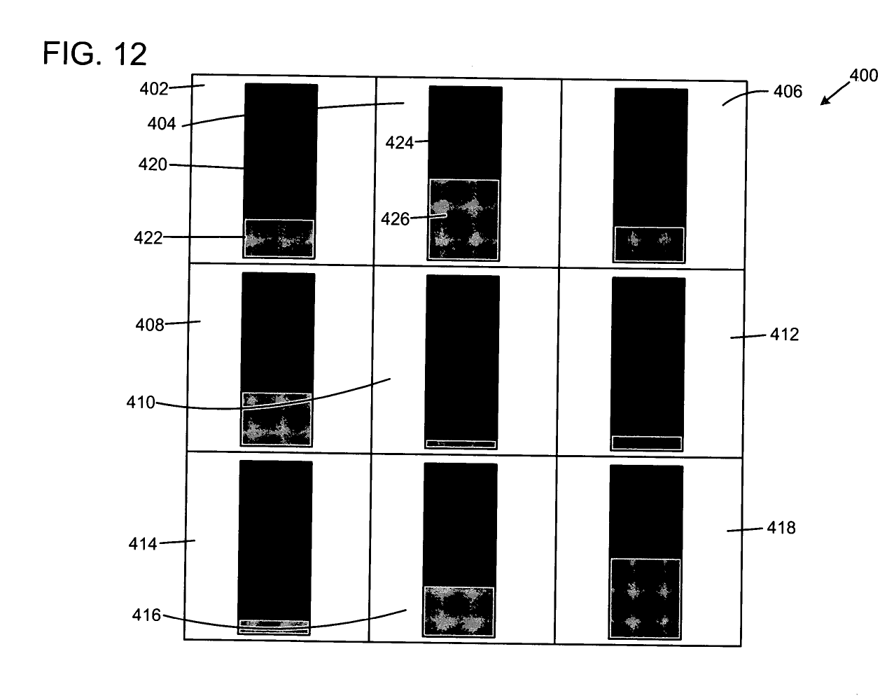

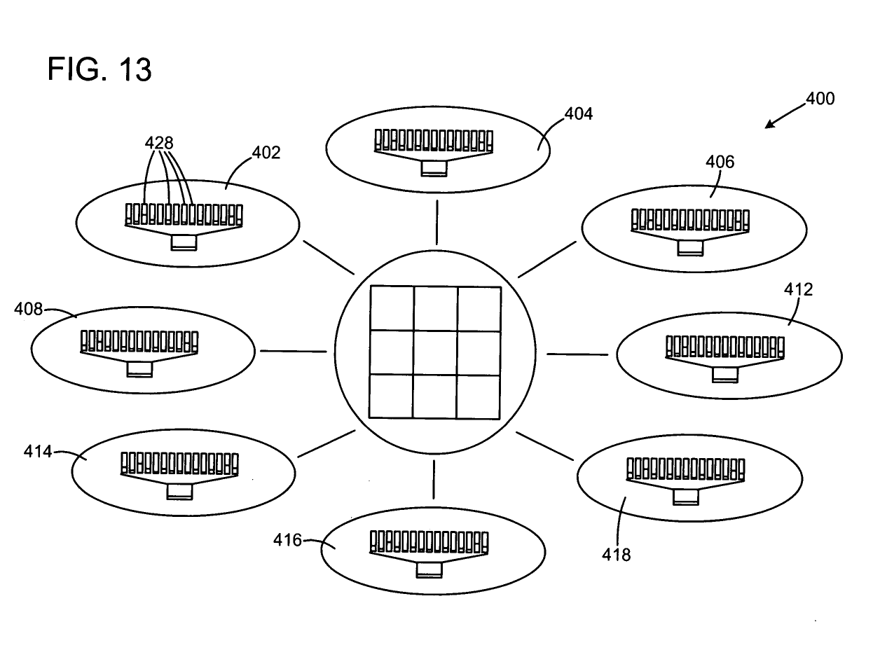

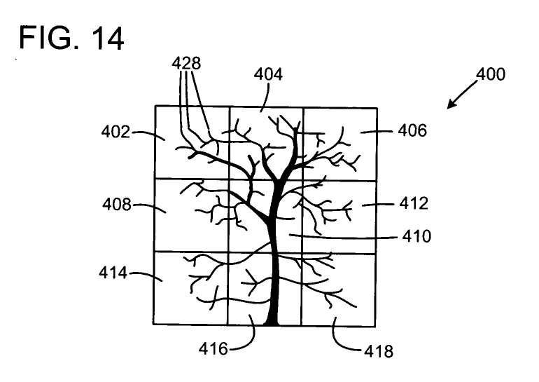

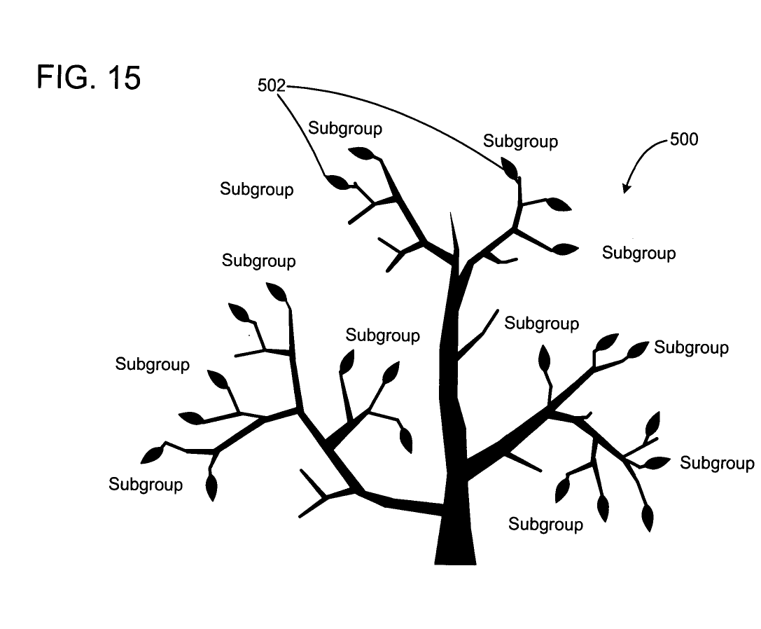

With reference to FIG. 10, the screen 34 may be related to customer relationship management (CRM) that includes customer information such as customer data, sales data, profit, products sold to customer, customer development plans agreements and customer/client information that could be a list of customers and products/contact information for each customer. More particularly, the alphabetical sorter 68 may include the sub-categories customer register 146. It may describe the sales process used for each client and the best method for each client

It is possible to organize the fields 1, 2, 3 of row 12 so that the corresponding screens 18, 20, 22 all relate to tool activities such as searching/navigating, adjustments of inflow and addition of news, information, reports etc. and communication of the individual. Similarly, the fields 4, 5, 6 of row 14 may be organized to relate to the context of the company such as plans/result/motivators, individual and role-based information while the fields 7, 8, 9 of row 16 are organized to relate to company contents such as products/services, company databases/knowledge and customer information. It is also possible to organize the fields so that the fields 3, 6, 9 relate to front-office customers/sales, the fields 2, 5, 8 related to individual/company information/knowledge/competence and the fields 1, 4, 7 relate to company back-office/business support for the fields 3, 6, 9 and the fields 2, 5, 8. With the above-outlined horizontal and vertical organization of the fields and rows, there is or appears to be a natural connection between and within the rows where the context-row is the steering-row.

While the present invention has been described in accordance with preferred compositions and embodiments, it is to be understood that certain substitutions and alterations may be made thereto without departing from the spirit and scope of the following claims.

1-10. (canceled)

11. A method of analyzing and searching in a network, comprising:
a screen displaying a plurality of business segments, each business segment having sensor points representing subgroups; determining conditions of each subgroup by allocating a quality indicator to each subgroup;
sweeping a radar line across the business segments; and each subgroup being lit up in the allocated quality indicator when the radar line extends across the subgroup.

12. The method according to claim 11 wherein the method further comprises the subgroup being lit up in red, yellow or green wherein red represents that a problem exists in the subgroup, yellow represents that a problem exists in the subgroup but that the problem is in the process of being solved and green represent that no problem exists in the subgroup.

13. The method according to claim 11 wherein the method further comprises rotating the radar line about a central point.

14. The method according to claim 11 wherein the method further comprises displaying each subgroup as a tree structure.

15. The method according to claim 11 wherein the method further comprises displaying each business segment in a green and red color to indicate a severity of an existing problem in the subgroup.

16. The method according to claim 14 wherein the method further comprises displaying the tree structure over the business segments of the screen so that branches and roots extend into the business segments.

17. The method according to claim 11 wherein the method further comprises providing the tree structure with branch and root ends so that each branch and root end represents a subgroup of the business segments.

18. The method according to claim 11 wherein the method further comprises displaying each subgroup of the business segments in a red and green color to indicate a condition of each subgroup.
